(19) United States
(12) Patent Application Publication
(10) Pub. No.: US 2025/0224823 A1
(43) Pub. Date: Jul. 10, 2025

(54) WRITING FEELING IMPROVEMENT FILM WITH PROTECTION FILM

(71) Applicant: LINTEC CORPORATION, Tokyo (JP)

(72) Inventors: Minami NAKANISHI, Tokyo (JP); Hiroki HOSHINO, Tokyo (JP)

(73) Assignee: LINTEC CORPORATION, Tokyo (JP)

(21) Appl. No.: 18/853,018

(22) PCT Filed: Dec. 2, 2022
(86) PCT No.: PCT/JP2022/044510

§ 371 Date: Sep. 30, 2024

(30) Foreign Application Priority Data
Mar. 31, 2022 (JP) 2022-061140

(51) Int. Cl. G06F 3/039; B32B 27/08; B32B 27/36

(52) U.S. Cl. CPC G06F 3/0393; B32B 27/08; B32B 27/36; B32B 2250/244; B32B 2255/10; B32B 2255/26; B32B 2307/748; B32B 2457/208; B32B 2571/00

(57) ABSTRACT

According to the present disclosure, provided is a protective film-equipped writing feel improving film which is formed by laminating a writing feel improving film having a writing feel improving film base material layer and a writing feel improving layer with a protective film having an adhesive layer and a protective film base material layer, thereby allowing the writing feel improving layer of the writing feel improving film and the adhesive layer of the protective film to be in contact with each other, in which a ratio of a maximum height of rolling circle waviness profile (WEM) of the writing feel improving layer to a thickness a (μm) of the adhesive layer (WEM/a) is 0.01 to 1.00, and even with temperature changes occurring during storage, transportation, processing, or the like, lifting or peeling off does not occur, allowing the quality of the writing feel improving film to be maintained.

### TECHNICAL FIELD

The present disclosure relates to a protective film-equipped writing feel improving film in which a protective film is laminated on a writing feel improving film for improving the writing feel on a touch panel or the like with a touch pen.

### BACKGROUND ART

In recent years, image display devices (touch panels) having a position detection function and serving both as a display device and as an input means are widely used in various electronic devices.

In such touch panels, it has been considered to attach a film for improving the writing feel (referred to as a “writing feel improving film,” hereinafter) with a touch pen to the outermost surface of the touch panel.

Disclosed writing feel improving films include a writing feel improving film having a writing feel improving layer with a specific frictional force (Patent Literature 1), an anti-glare hard coat film for touch panels with pen tip resistance of a touch pen and oleic acid contact angle regulated (Patent Literature 2), a transparent film having a specific total luminous transmittance and a specific maximum height of rolling circle waviness profile (Patent Literature 3), a tactile film containing linear convex portions forming a network structure (Patent Literature 4), and a transparent laminated film having a surface profile with a specific maximum height of rolling circle waviness profile and arithmetic average roughness (Patent Literature 5).

However, these documents do not describe a laminate in which a protective film is laminated on a writing feel improving film.

### CITATION LIST

### Patent Literature

Patent Literature 1: WO2020/122172 (US2022/0033600A1)
Patent Literature 2: Unexamined Japanese Patent Application Publication No. 2014-232276A
Patent Literature 3: Unexamined Japanese Patent Application Publication No. 2014-97649A (US2015/0291828A1)
Patent Literature 4: Unexamined Japanese Patent Application Publication No. 2015-54417A
Patent Literature 5: Unexamined Japanese Patent Application Publication No. 2016-196113A (US2018/0030229A1)

### SUMMARY OF INVENTION

### Technical Problem

After being produced, such a writing feel improving films is stored, transported, processed, and the like. Therefore, a protective film may be attached (laminated) to the surface of the writing feel improving film in order to protect the surface of the film until the writing feel improving film is used in a touch panel. A writing feel improving film having a protective film laminated on its surface (hereinafter referred to as a “protective film-equipped writing feel improving film”) may be exposed to high temperatures (40° C. to 60° C.) for a long period during storage or transportation or may be processed under high temperatures (50° C. to 90° C.) during processing.

However, such temperature changes cause the film to lift (tunneling) or peel off, which can lead to a problem of degraded quality of the writing feel improving film.

The present disclosure has been made in consideration of such actual circumstances and an object of the present disclosure is to provide a protective film-equipped writing feel improving film that is prevented from lifting or peeling off due to a temperature change.

### Solution to Problem

The present inventors conducted intensive studies on the protective film-equipped writing feel improving film to solve the problem above. As a result, the present inventors found that the problem can be solved by setting a ratio of maximum height of rolling circle waviness profile (WEM) of a writing feel improving layer to a thickness a (μm) of an adhesive layer of a protective film (WEM/a) to have a specific range. This has led to the completion of the present disclosure.

Thus, according to the present disclosure, the protective film-equipped writing feel improving films of the following [1] to [3] are provided.

[1]A protective film-equipped writing feel improving film which is formed by laminating a writing feel improving film having a writing feel improving film base material layer and a writing feel improving layer with a protective film having an adhesive layer and a protective film base material layer, thereby allowing the writing feel improving layer of the writing feel improving film and the adhesive layer of the protective film to be in contact with each other, wherein a ratio of a maximum height of rolling circle waviness profile (WEM) of the writing feel improving layer to a thickness a (μm) of the adhesive layer (WEM/a) is 0.01 to 1.00.

[2] The protective film-equipped writing feel improving film according to [1], wherein the maximum height of rolling circle waviness profile (WEM) of the writing feel improving layer is 0.1 in to 20 μm.

[3] The protective film-equipped writing feel improving film according to [1] or [2], wherein the thickness a (μm) of the adhesive layer is 5 in to 50 μm.

[4] The protective film-equipped writing feel improving film according to [1] or [2], wherein a delamination force between the writing feel improving film and the protective film is 800 mN/25 mm or less.

### Advantageous Effect of Invention

According to the protective film-equipped writing feel improving film of the present disclosure, the writing feel improving film is prevented from lifting or peeling off due to a temperature change during storage, transportation, processing, or the like, maintaining the quality of the writing feel improving film.

### BRIEF DESCRIPTION OF DRAWINGS

FIG. 1 is a schematic diagram illustrating an example of the layer structure of the protective film-equipped writing feel improving film of the present disclosure.

### DESCRIPTION OF EMBODIMENTS

The protective film-equipped writing feel improving film of the present disclosure is a protective film-equipped writing feel improving film which is formed by laminating a writing feel improving film having a writing feel improving film base material layer and a writing feel improving layer with a protective film having an adhesive layer and a protective film base material layer, thereby allowing the writing feel improving layer of the writing feel improving film and the adhesive layer of the protective film to be in contact with each other, wherein a ratio of a maximum height of rolling circle waviness profile (WEM) of the writing feel improving layer to a thickness a (μm) of the adhesive layer (WEM/a) is 0.01 to 1.00.

Hereinafter, the protective film-equipped writing feel improving film of the present disclosure is described in detail.

### 1) Writing Feel Improving Film

The writing feel improving film according to the present embodiment has a writing feel improving film base material layer and a writing feel improving layer.

### (1) Writing Feel Improving Film Base Material Layer

The writing feel improving film base material layer according to the present embodiment has the role of carrying the writing feel improving layer.

As the material for the writing feel improving film base material layer, a transparent material can be appropriately selected from conventionally known materials as base materials.

Examples of such materials include polyesters films such as a polyethylene terephthalate film, a polybutylene terephthalate film, and a polyethylene naphthalate film, polyolefin films such as a polyethylene film and a polypropylene film, a diacetyl cellulose film, a triacetyl cellulose film, an acetyl cellulose butyrate film, a polyvinyl chloride film, a polyvinylidene chloride film, a polyvinyl alcohol film, an ethylene-vinyl acetate copolymer film, a polystyrene film, a polycarbonate film, a polymethylpentene film, a polysulfone film, a polyether ether ketone film, a polyether sulfone film, a polyether imide film, a polyimide film a fluorine resin film, a polyamide film, an acrylic resin film, a polyurethane resin film, a norbomene-based polymer film, a cyclic olefin-based polymer film, a cyclic conjugated diene-based polymer film, a vinyl alicyclic hydrocarbon polymer film, a polyphenylene sulfide film, a liquid crystal polymer film; cellophane; glass; and laminated films thereof.

Among these, a polyethylene terephthalate film, a polycarbonate film, an acrylic resin film, a norbomene-based polymer film, and the like are preferred from the viewpoint that they can well maintain the writing feel with a touch pen in combination with the writing feel improving layer, and a polyethylene terephthalate polycarbonate film, a polymethyl methacrylate film, and a composite base material thereof are particularly preferred.

For the purpose of improving the interfacial adhesion between the writing feel improving film base material layer and a writing feel improving layer provided on the surface thereof, if desired, the surface on which a writing feel improving layer is formed can be subjected to surface treatment, such as by an oxidation method or a roughening method, a primer treatment, or the like.

Examples of the oxidation method include corona discharge treatment, plasma discharge treatment, chromic acid treatment (wet method), flame treatment, hot-air treatment, and ozone/ultraviolet treatment.

Examples of the roughening method include a sandblast method and a solvent treatment method.

The primer treatment can be carried out by a known method, such as coating the surface of the writing feel improving film base material layer with an adhesive resin material.

These surface treatments may be appropriately selected depending on the material of the base material layer.

The thickness of the writing feel improving film base material layer is preferably 30 to 300 μm, more preferably 90 to 250 μm, particularly preferably 120 to 220 μm, and further preferably 150 to 200 μm, from the viewpoints of adequately supporting the writing feel improving layer, processability, protection of a touch panel, and resistance to writing with a touch pen.

### (2) Writing Feel Improving Layer

The writing feel improving layer according to the present embodiment has a function of improving the writing feel with a touch pen.

Here, “improving the writing feel with a touch pen” means that in the case of writing on the writing feel improving layer with a touch pen, the feeling of vibration that occurs when writing with a ballpoint pen on paper can be reproduced, and the feeling of resistance (degree of friction) that occurs when writing with a ballpoint pen on paper can be reproduced.

The writing feel improving layer can be formed using a composition for forming a writing feel improving layer.

A composition for forming a writing feel improving layer can be prepared by, for example, mixing a curable component, fine particles, a surface conditioner, and the like.

### (2-1) Curable Component

The composition for forming a writing feel improving layer according to the present embodiment is preferably one containing a curable component as a main component.

The curable component is a component that is cured by active energy rays such as visible light, ultraviolet light, and an electron beam, or by heat or the like. Examples thereof include an active energy ray-curable component and a heat-curable component.

In particular, it may be preferred to use the active energy ray-curable component from the viewpoint of the hardness of the writing feel improving layer formed, the heat resistance of the writing feel improving film base material layer, and the like. A writing feel improving film provided with a writing feel improving layer formed from such materials tends to have a desired WEM value, and satisfy the above-described WEM/a value.

Examples of the active energy ray-curable component include a polyfunctional (meth)acrylate monomer, a (meth)acrylate prepolymer, and an active energy ray-curable polymer. Among these, a polyfunctional (meth)acrylate monomer and/or a (meth)acrylate prepolymers are preferred, and a polyfunctional (meth)acrylate monomer is more preferred since they have a predetermined hardness and can achieve an improved writing feel with a touch pen. A writing feel improving film provided with a writing feel improving layer formed from such materials tends to have a desired WEM value, and satisfy the above-described WEM/a value.

The polyfunctional (meth)acrylate monomer and the (meth)acrylate prepolymer may be used alone or in combination.

Herein, the term “(meth)acrylate” means an acrylate and/or methacrylate. The same applies to other similar terms.

Examples of the polyfunctional (meth)acrylate-based monomer include 1,4-butanediol di(meth)acrylate, 1,6-hexanediol di(meth)acrylate, neopentyl glycol di(meth)acrylate, polyethylene glycol di(meth)acrylate, hydroxypivalic acid neopentyl glycol di(meth)acrylate, dicyclopentanyl di(meth)acrylate, caprolactone-modified dicyclopentenyl di(meth)acrylate, ethylene oxide-modified phosphoric acid di(meth)acrylate, allylated cyclohexyl di(meth)acrylate, isocyanurate di(meth)acrylate, trimethylol propane tri(meth)acrylate, dipentaerythritol tri(meth)acrylate, propionic acid-modified dipentaerythritol tri(meth)acrylate, pentaerythritol tri(meth)acrylate, propylene oxide-modified trimethylolpropane tri(meth)acrylate, tris(acryloxyethyl)isocyanurate, pentaerythritol tetra(meth)acrylate, propionic acid-modified dipentaerythritol penta(meth)acrylate, dipentaerythritol hexa(meth)acrylate, ethylene oxide-modified dipentaerythritol hexa(meth)acrylate, caprolactone-modified dipentaerythritol hexa(meth)acrylate, and other appropriate polyfunctional (meth)acrylates.

These can each be used alone or two or more types can also be used in combination.

Examples of the (meth)acrylate-based prepolymer include polyester acrylate-based, epoxy acrylate-based, urethane acrylate-based, and polyol acrylate-based prepolymers.

The polyester acrylate-based prepolymer can be obtained through preparing a polyester oligomer having hydroxyl groups at both ends obtained by condensation of a polycarboxylic acid and a polyalcohol and esterifying the hydroxyl groups of the polyester oligomer with (meth)acrylic acid, or through preparing an oligomer obtained by adding an alkylene oxide to a polycarboxylic acid and esterifying the hydroxyl group at an end of the oligomer with (meth)acrylic acid.

The epoxy acrylate-based prepolymer can be obtained through reacting (meth)acrylic acid with the oxirane ring of a relatively low-molecular-weight bisphenol-type epoxy resin or novolak-type epoxy resin to esterify it.

The urethane acrylate-based prepolymer can be obtained through preparing a polyurethane oligomer obtained by a reaction between a polyether polyol or a polyester polyol and a polyisocyanate and esterifying the polyurethane oligomer with (meth)acrylic acid.

The polyol acrylate-based prepolymer can be obtained through esterifying a hydroxyl group of a polyether polyol with (meth)acrylic acid.

The prepolymers can each be used alone or two or more types can also be used in combination.

### (2-2) Fine Particles

The composition for forming a writing feel improving layer according to the present embodiment preferably contains fine particles. By containing fine particles, the surface of the writing feel improving layer formed can be a moderately rough surface so that the average value, maximum value, minimum value, and standard deviation of the frictional force described below can be readily adjusted within the desired ranges. As a result, with obtained writing feel improving film, moderate feelings of friction and vibration can be developed when writing on the writing feel improving layer with a touch pen, making it possible to well reproduce the writing feel experienced when writing on paper with a ballpoint pen. In addition, the obtained writing feel improving film tends to have a desired WEM value and satisfy the above-described WEM/a value.

The above-described fine particles refer to particles having an average particle diameter larger than that of the silica nanoparticles described below. For example, the average particle diameter of the fine particles is preferably 1 to 30 μm, more preferably 3 to 24 μm, particularly preferably 6 to 18 μm, further preferably 9 to 16 μm, and still further preferably 11 to 14 μm. By using fine particles having an average particle diameter within the above-described range, the average value, maximum value, minimum value, and standard deviation of the frictional force described below can be readily adjusted within the desired ranges, thereby imparting moderate feelings of friction and vibration to the writing feel improving layer. This makes it possible to well reproduce the writing feel experienced when writing on paper with a ballpoint pen. Moreover, the WEM can be readily adjusted to the desired value, and particularly when the writing feel improving film is combined with a protective film, an excellent peeling off suppression effect tends to be exhibited. The above-described average particle diameter of the fine particles refers to values measured with a laser diffraction and scattering-type particle diameter distribution measurement device using a few drops of a dispersion liquid as a sample. The dispersion liquid may be prepared with methyl ethyl ketone as a dispersion medium and may have a concentration of 5% by mass.

The above fine particles may be inorganic fine particles, organic fine particles, or resin fine particles having both inorganic and organic properties. In particular, from the viewpoints of the hardness of the writing feel improving layer formed and of making it easier to adjust the WEM to the desired value, the inorganic fine particles or resin fine particles having both inorganic and organic properties are preferred, and the resin fine particles having both inorganic and organic properties are particularly preferred.

Examples of the inorganic fine particles include fine particles composed of silica, alumina, titania, zirconia, tin oxide, indium oxide, cadmium oxide, antimony oxide, and the like. Among these, the silica fine particles are preferred.

Examples of organic fine particles include melamine-based resin fine particles, acrylic-based resin fine particles (such as polymethyl methacrylate resin fine particles), acrylic-styrene copolymer fine particles, polycarbonate-based fine particles, polyethylene-based fine particles, polystyrene-based fine particles, and benzoguanamine-based resin fine particles. The resin constituting the resin fine particles may be crosslinked. Among these, from the viewpoints of optical properties and hardness, acrylic-based resin fine particles are preferred, and polymethyl methacrylate resin fine particles are more preferred.

Preferred examples of resin fine particles having both inorganic and organic properties include silicone fine particles (for example, Tospearl series available from Momentive Performance Materials Japan).

In order to further improve dispersibility, it is also preferable that the surfaces of the fine particles are modified with a surface modifier.

In addition, the shape of the fine particles may be spherical or non-spherical. In the case of a non-spherical shape, the shape may be an indefinite shape or a shape with a high aspect ratio, such as a needle shape or a scale shape. In this specification, the term “indefinite shape” refers to a shape having many irregular corners or faces rather than a regular shape such as a sphere or an ellipse. From the viewpoints of making it easier to adjust the average value, maximum value, minimum value, and standard deviation of the frictional force described below of the resulting writing feel improving layer within the desired ranges and of making it easier to adjust WEM to the desired value, the shape of the fine particles is preferably spherical and particularly preferably genuinely spherical.

The fine particles can each be used alone or two or more types can also be used in combination.

The content of the fine particles in the composition for forming a writing feel improving layer is preferably 0.1 to 20 parts by mass, more preferably 0.5 to 17 parts by mass, particularly preferably 1 to 14 parts by mass, further preferably 3 to 12 parts by mass, and still further preferably 6 to 11 parts by mass with respect to 100 parts by mass of the curable component. Since the content of the fine particles is within the above-described range, the average value, maximum value, minimum value, and standard deviation of the frictional force described later can be readily adjusted within the desired ranges for the resulting writing feel improving layer. In addition, WEM can be readily adjusted to the desired value, and particularly when combined with a protective film, an excellent peeling off suppression effect tends to be exhibited.

### (2-3) Surface Conditioner

The composition for forming a writing feel improving layer according to the present embodiment preferably contains a surface conditioner.

When the composition contains a surface conditioner, generation of streaky defects, unevenness, and the like can be suppressed in the writing feel improving layer formed. This allows the film thickness to be uniform, and the writing feel improving film can have a more excellent appearance and can readily have desired optical properties (such as the haze value and the total luminous transmittance). In addition, the average value, maximum value, minimum value, and standard deviation of the frictional force described later can be readily adjusted within the desired ranges because the surface of the writing feel improving layer of the writing feel improving film tends to be an excellent surface, allowing the writing feel of the writing feel improving layer to be even more excellent. Moreover, the WEM can be readily adjusted to the desired value, and particularly when the writing feel improving film is combined with a protective film, an excellent curling suppression effect tends to be exhibited.

Examples of the surface conditioner include a silicone-based surface conditioner consisting of a silicone-based polymer, a fluorine-based surface conditioner consisting of a fluorine-based polymer, an acrylic-based surface conditioner consisting of an acrylic-based polymer, and a vinyl-based surface conditioner consisting of a vinyl polymer.

Here, the silicone-based polymer means a polymer mainly consisting of polysiloxane chains, and the fluorine-based polymer means a polymer having a fluorine-substituted monomer as a main monomer unit. The acrylic-based polymer means a polymer having an acrylic acid ester as a main monomer unit. The vinyl-based polymer means a polymer having a vinyl group-containing monomer as a main monomer unit.

The surface conditioners can each be used alone or two or more types can also be used in combination.

Among these, the silicone-based surface conditioner and the fluorine-based surface conditioner may be preferred from the viewpoint of the surface conditioning properties and the compatibility with other components.

The silicone-based surface conditioner may preferably be a surface conditioner consisting of polydimethylsiloxane or modified polydimethylsiloxane and may particularly preferably be a surface conditioner consisting of polydimethylsiloxane.

A preferred fluorine-based surface conditioner is a surface conditioner consisting of a compound having a perfluoroalkyl group or a fluorinated alkenyl group in the main chain or a side chain. Examples of commercially available products include, but are not limited to, BYK-340 available from BYK Japan KK., Ftergent 650A available from NEOS COMPANY LIMITED, Megafac RS-75 available from DIC, Megafac RS-90 available from DIC, and V-8FM available from OSAKA ORGANIC CHEMICAL INDUSTRY LTD.

In a case in which the composition for forming a writing feel improving layer contains a surface conditioner, the content of the surface conditioner in the composition for forming a writing feel improving layer is preferably 0.01 to 10 parts by mass, more preferably 0.1 to 5 parts by mass, particularly preferably 0.5 to 3 parts by mass, and further preferably 0.8 to 2 parts by mass with respect to 100 parts by mass of the curable component. Since the content of the surface conditioner is within the above-described range, the appearance of the writing feel improving film can be even more excellent. Moreover, the average value, maximum value, minimum value, and standard deviation of the frictional force described below can be readily adjusted within the desired ranges so that the writing feel of the writing feel improving layer can be even more excellent.

### (2-4) Other Components

The composition for forming a writing feel improving layer may further contain other components in addition to the above ingredients. Examples of such other components include silica nanoparticles, a photopolymerization initiator, an ultraviolet absorber, an antioxidant, a light stabilizer, an antistatic, a silane coupling agent, an antiaging agent, a thermal polymerization inhibitor, a surfactant, a storage stabilizer, a plasticizer, a glidant, an antifoam, an organic-based filler, a wettability improving agent, and a coating surface improving agent.

When the composition for forming a writing feel improving layer contains silica nanoparticles, the hardness and scratch resistance of the writing feel improving layer formed can be effectively improved, facilitating a contribution to suppressing peeling off. In addition, the optical properties (haze value, total luminous transmittance, and the like) of the writing feel improving film can be improved, and the occurrence of glare when the writing feel improving film is used can be effectively suppressed.

The average particle diameter of silica nanoparticles is preferably 1 to 300 nm, more preferably 5 to 100 nm, and particularly preferably 10 to 50 nm. The average particle diameter of silica nanoparticles can be measured by a laser diffraction and scattering-type particle diameter distribution measurement device.

The silica nanoparticles may be in the form of an organosol (colloidal form). When the silica nanoparticles are in the form of an organosol, the dispersibility of the silica nanoparticles may be satisfactory, and the homogeneity and light transmittance of the writing feel improving layer formed may be improved.

In a case in which the composition for forming a writing feel improving layer contains silica nanoparticles, the content of the silica nanoparticles in the composition for forming a writing feel improving layer is preferably 5 to 50 parts by mass, more preferably 10 to 35 parts by mass, and particularly preferably 15 to 25 parts by mass with respect to 100 parts by mass of the curable component.

By setting the compounding ratio of the silica nanoparticles within the above-described range, the homogeneity and light transmittance of the writing feel improving layer formed can be maintained at higher levels.

In a case in which the composition for forming a writing feel improving layer contains an active energy ray-curable component as a curable component, a photopolymerization initiator may also be preferably contained. When a photopolymerization initiator is contained, the curing reaction caused by irradiation with active energy rays can proceed more readily.

Examples of the photopolymerization initiator used include benzoin, benzoin methyl ether, benzoin ethyl ether, benzoin isopropyl ether, benzoin-n-butyl ether, benzoin isobutyl ether, acetophenone, dimethylaminoacetophenone, 2,2-dimethoxy-2-phenylacetophenone, 2,2-diethoxy-2-phenylacetophenone, 2-hydroxy-2-methyl-1-phenylpropan-1-one, 1-hydroxycyclohexyl phenyl ketone, 2-methyl-1-[4-(methylthio)phenyl]-2-morpholino-propan-1-one, 4-(2-hydroxyethoxy)phenyl-2-(hydroxy-2-propyl)ketone, benzophenone, p-phenylbenzophenone, 4,4′-diethylaminobenzophenone, dichlorobenzophenone, 2-methylanthraquinone, 2-ethylanthraquinone, 2-tert-butylanthraquinone, 2-aminoanthraquinone, 2-methylthioxanthone, 2-ethylthioxanthone, 2-chlorothioxanthone, 2,4-dimethylthioxanthone, 2,4-diethylthioxanthone, benzyl dimethyl ketal, acetophenone dimethyl ketal, and p-dimethylaminobenzoic ester. These may each be used alone or two or more types may also be used in combination. These can each be used alone or two or more types can also be used in combination.

In a case in which the composition for forming a writing feel improving layer contains a photopolymerization initiator, the content of the photopolymerization initiator in the composition for forming a writing feel improving layer is preferably 1 to parts by mass and more preferably 2 to 10 parts by mass with respect to 100 parts by mass of the curable component from the viewpoint of the effect of adding the photopolymerization initiator.

The composition for forming a writing feel improving layer may contain a solvent for improvement of coating properties, adjustment of viscosity, adjustment of solid content concentration, and the like.

The solvent used is not particularly limited, provided that it dissolves curable components and the like and disperses fine particles and the like. Specific examples of the solvent include alcohols such as methanol, ethanol, isopropanol, butanol, and octanol; ketones such as acetone, methyl ethyl ketone, methyl isobutyl ketone, and cyclohexanone; esters such as ethyl acetate, butyl acetate, ethyl lactate, and γ-butyrolactone; ethers such as ethylene glycol monomethyl ether (methyl cellosolve), ethylene glycol monoethyl ether (ethyl cellosolve), diethylene glycol monobutyl ether (butyl cellosolve), and propylene glycol monomethyl ether; aromatic hydrocarbons such as benzene, toluene, and xylene; and amides such as N,N-dimethylformamide, N,N-dimethylacetamide, and N-methylpyrrolidone.

The solvents can each be used alone or two or more types can also be used in combination.

The content of the solvent is usually from 10 to 300 parts by mass and preferably from 30 to 200 parts by mass with respect to 100 parts by mass of the curable component.

### (3) Method of Forming Writing Feel Improving Layer

The writing feel improving layer can be formed by applying the composition for forming a writing feel improving layer on the writing feel improving film base material layer to a desired thickness and drying and curing the resulting coating film.

The method for applying the composition for forming a writing feel improving layer may be a conventionally known application method, such as a bar coating method, a knife coating method, a roll coating method, a blade coating method, a die coating method, or a gravure coating method.

The drying temperature for the coating film of the composition for forming a writing feel improving layer obtained is usually 40° C. to 120° C., and the drying time is usually about 30 seconds to 5 minutes.

In a case in which the curable component in the composition for forming a writing feel improving layer has active energy ray curability, the coating film of the composition for forming a writing feel improving layer may be cured by irradiating the coating film with active energy rays such as ultraviolet rays and electron rays.

Irradiation with ultraviolet rays can be performed using a high-pressure mercury lamp, an H lamp available from Heraeus K.K., a xenon lamp, or the like, and the irradiance level of ultraviolet rays may be preferably about 50 to 1,000 mW/cm² as the illuminance and about 50 to 1,000 mJ/cm² as the light amount and more preferably about 100 to 500 mW/cm² as the illuminance and about 100 to 500 mJ/cm² as the light amount.

Irradiation with electron rays can be performed using an electron ray accelerator or the like, and the irradiance level of electron rays may be preferably about 10 to 1,000 krad.

In a case in which the curable component in the composition for forming a writing feel improving layer has thermosetting properties, the coating film of the composition for forming a writing feel improving layer may be cured by heating the coating film at a specified temperature for a specified time.

The thickness of the writing feel improving layer formed is not particularly limited but is preferably 0.8 to 30 μm, more preferably 1 to 20 μm, particularly preferably 2 to 15 μm, further preferably 3 to 12 μm, still further preferably 4 to 10 μm, and most preferably 5 to 8 μm. When the thickness of the writing feel improving layer is within the above range, this makes it possible to better reproduce the writing feel experienced when writing on paper with a ballpoint pen. Moreover, the WEM can be readily adjusted to the desired value, and particularly when the writing feel improving film is combined with a protective film, an excellent curling suppression effect tends to be exhibited.

The writing feel improving layer according to the present disclosure has a surface with an appropriate irregular structure. The maximum height of rolling circle waviness profile (WEM) of the writing feel improving film (writing feel improving layer surface) is preferably 0.1 μm or more, more preferably 0.5 μm or more, particularly preferably 1.0 μm or more, and further preferably 2.0 μm or more. In addition, the maximum height of rolling circle waviness profile (WEM) of the writing feel improving layer surface is preferably 20 μm or less, more preferably 16.0 μm or less, particularly preferably 12.0 μm or less, further preferably 8.0 μm or less, still further preferably 5.0 μm or less, and most preferably 3.0 μm or less.

When the WEM is in this range, it is estimated that when inputting with a touch pen on a touch panel, the pen tip may be moderately caught on a convex portion, and the writing feel can be adjusted to be approximately constant at the start and midway of pen input. In addition, the average value, maximum value, minimum value, and standard deviation of the frictional force described later can be readily adjusted within the desired ranges, allowing the writing feel of the writing feel improving layer to be even more excellent. Moreover, when a writing feel improving layer having a surface shape exhibiting a WEM within the above-described range is attached to the writing feel improving layer with an adhesive layer of a protective film, the thickness of the adhesive layer and the surface shape of the writing feel improving layer having moderate irregularities can exhibit moderate adhesion. This prevents peeling off even when temperature changes are imparted during storage, transportation, processing, and the like.

As described later, this WEM needs to be designed so that the ratio (WEM/a) of the protective film to the thickness a (μm) of the adhesive layer is 0.01 to 1.00, preferably more than 0.01 and less than 1.00, more preferably 0.03 to 0.80, particularly preferably 0.06 to 0.70, and further preferably 0.07 to 0.60.

The maximum height of rolling circle waviness profile (WEM) of the writing feel improving layer can be measured in accordance with JIS B0610:2001. In detail, it can be measured by the method described in Examples below.

The arithmetic average roughness (Ra) of the writing feel improving film (writing feel improving layer surface) is preferably 0.1 to 1 μm, more preferably 0.2 to 0.9 μm, particularly preferably 0.3 to 0.8 μm, and further 0.4 to 0.7 μm.

The ten-point average roughness (RzJIS) of the writing feel improving film (writing feel improving layer surface) is preferably 1 to 15 μm, more preferably 3 to 10 μm, and particularly preferably 5 to 8 μm.

Since the arithmetic average roughness (Ra) and ten-point average roughness (Rz) of the writing feel improving film (writing feel improving layer surface) are such values, the average value, maximum value, minimum value, and standard deviation of the frictional force described later can be readily adjusted within the desired ranges, allowing the writing feel of the writing feel improving layer to be even more excellent. Furthermore, in combination with the above-described WEM, the writing feel improving layer has a surface shape with moderate irregularities, and thus, when the writing feel improving layer is attached to the adhesive layer of the protective film, the adhesive layer and the writing feel improving layer can exhibit moderate adhesion. This prevents peeling off even when temperature changes are imparted during storage, transportation, processing, and the like.

The arithmetic average roughness (Ra) and the ten-point average roughness (RzJIS) can be measured using a surface roughness measuring device in accordance with JIS B0601:2013.

The average frictional force between the writing feel improving film (writing feel improving layer surface) and the touch pen (stylus pen) when writing is preferably 100 to 1200 mN, more preferably 200 to 800 mN, particularly preferably 250 to 500 mN and further preferably 300 to 400 mN.

The maximum value of the frictional force between the writing feel improving film (writing feel improving layer surface) and the touch pen (stylus pen) during writing is preferably 200 to 1500 mN, more preferably 250 to 1000 mN, and further preferably 300 to 600 mN.

The minimum value of the frictional force between the writing feel improving film (writing feel improving layer surface) and the touch pen (stylus pen) when writing is preferably 80 to 1200 mN, more preferably 120 to 1000 mN, particularly preferably 200 to 700 mN, and further preferably 240 to 500 mN.

The standard deviation of frictional force between the writing feel improving film (writing feel improving layer surface) and the touch pen (stylus pen) when writing is preferably 10 to 60 mN, more preferably 12 to 45 mN, particularly preferably 14 to 30 mN, and further preferably 16 to 20 mN.

When either or all of the average value, maximum value, minimum value, and standard deviation of the above-described frictional force fall within the above-described ranges, the feeling of vibration transmitted to the hand holding the touch pen can be readily reproduced as the feeling of vibration obtained when writing on paper with a ballpoint pen. The above-described physical properties relating to frictional force can be measured by the method described in Examples below.

The writing feel improving layer surface of the writing feel improving film according to the present disclosure is excellent in scratch resistance. Preferably, there is no change in appearance when the scratch resistance is evaluated using steel wool. Specifically, when the surface of the writing feel improving layer is rubbed at a load of 250 g/cm² using #0000 steel wool to reciprocate it ten times within a length of 10 cm in accordance with JIS K5600-5-10, it is preferred that not more than three scratches be generated on the surface, and it is more preferred that no scratches be generated on the surface. As a result, when used on the surface of a display, such as a touch panel, excellent surface protection properties are exhibited, and the aesthetic appearance of the touch panel can be well maintained.

The scratch resistance can be evaluated by the method described in the Test Examples described below.

The pencil hardness of the writing feel improving film (writing feel improving layer surface) according to the present disclosure is preferably H or more, more preferably 2H or more, particularly preferably 3H or more, and further preferably 4H or more. The pencil hardness is usually 9H or less, preferably 7H or less, and more preferably 5H or less. By having this hardness, the writing feel improving film has excellent scratch resistance and exhibits excellent surface protection properties when used on the surface of a display such as a touch panel. In particular, the surface is less susceptible to scratches so that the aesthetic appearance of the touch panel can be well maintained.

Pencil hardness can be measured using a pencil scratch hardness tester in accordance with JIS K5600.

The total luminous transmittance (%) of the writing feel improving film according to the present disclosure is preferably 80% or more, more preferably 85% or more, and further preferably 90% or more. This makes the writing feel improving film excellent in transparency, and when applied to a touch panel, it can provide favorable image visibility. The upper limit of total luminous transmittance is usually 100%.

The total luminous transmittance can be measured in accordance with JIS K 7361-1 using a haze meter by irradiating light from the writing feel improving layer side after blank correction.

The haze of the writing feel improving film (writing feel improving layer surface) of the present disclosure is preferably 0% to 50%, more preferably 1% to 40%, particularly preferably 5% to 30%, and further preferably 10% to 22%. This makes the writing feel improving film excellent in transparency, and when applied to a touch panel, it can provide favorable image visibility.

Haze can be measured using a haze meter in accordance with JIS K 7136:2000.

### 2) Protective Film

The protective film-equipped writing feel improving film according to the present disclosure uses a protective film including a protective film base material layer and an adhesive layer. The protective film has the role of preventing the writing feel improving film surface from being scratched or stained.

### (1) Protective Film Base Material Layer

The material for the protective film base material layer according to the present embodiment is not particularly limited, and examples thereof include conventionally known materials used as protective film base material layers for optical films. Specifically, the same materials as those exemplified as the writing feel improving film base material layer can be mentioned.

Among these, from the viewpoints of ease of handling, availability, and the ease with which the effects of the present disclosure can be obtained, a polyethylene terephthalate film, a polybutylene terephthalate film, a polyethylene naphthalate film, a polycarbonate film, a polypropylene film, a polyimide film, a polyetherimide film, a polymethylpentene film, a polyphenylene sulfide film, and a liquid crystal polymer film are preferable, and a polyethylene terephthalate film, a polypropylene film, and a polycarbonate film are more preferable.

The protective film base material layer may be a single layer consisting of one of these films or a laminate of two or more of these films.

The protective film base material layer may be subjected to a surface treatment such as an oxidation method or a roughening method, or a primer treatment, as described above in the section on the writing feel improving film base material layer. These surface treatment methods are appropriately selected depending on the type of protective film base material layer or the like.

The thickness of the protective film base material layer is appropriately set in consideration of workability, cost, and the like. The thickness of the protective film base material layer is preferably 10 to 300 μm, more preferably 20 to 200 μm, particularly preferably 25 to 150 μm further preferably 30 to 120 μm, and still further preferably 35 to 110 μm. This makes it easier for the delamination force described later to fall within the specific range.

### (2) Adhesive Layer

The protective film base material layer and the writing feel improving film can be adhered more readily and firmly via an adhesive layer.

Any adhesive that is generally used for optical film application can be used as an adhesive that constitutes the adhesive layer, and examples thereof include an acrylic-based pressure sensitive adhesive, a rubber-based pressure sensitive adhesive, a silicone-based pressure sensitive adhesive, a urethane-based pressure sensitive adhesive, a polyester-based pressure sensitive adhesive, and a polyvinyl ether-based pressure sensitive adhesive. The adhesive may be of the emulsion type, solvent type, or solventless type. Furthermore, the adhesive may or may not have a crosslinked structure.

Among these, from the viewpoints of exhibiting the desired adhesiveness and excellent optical properties and durability, an acrylic-based adhesive containing a (meth)acrylic acid ester polymer as a base polymer is preferable, and an acrylic-based adhesive containing a (meth)acrylic acid ester polymer as a base polymer and having a crosslinked structure is more preferable. Herein, the term “polymer” also includes the concept of “copolymer.”

The monomer units constituting the above-described (meth)acrylic acid ester polymer can be appropriately selected from the viewpoints of transparency, adhesive strength, and the like. In particular, preferably, the polymer contains a (meth)acrylic acid alkyl ester and a monomer having a reactive functional group in the molecule (reactive functional group-containing monomer).

The (meth)acrylic acid ester polymer can exhibit preferable adhesiveness by containing a (meth)acrylic acid alkyl ester as a monomer unit constituting the polymer. As the (meth)acrylic acid alkyl ester, a (meth)acrylic acid alkyl ester having an alkyl group with 1 to 20 carbon atoms is preferable. The alkyl group may be linear or branched or have a cyclic structure.

Examples of a (meth)acrylic acid alkyl ester having an alkyl group with 1 to carbon atoms include methyl (meth)acrylate, ethyl (meth)acrylate, propyl (meth)acrylate, n-butyl (meth)acrylate, n-pentyl (meth)acrylate, n-hexyl (meth)acrylate, 2-ethylhexyl (meth)acrylate, isooctyl (meth)acrylate, n-decyl (meth)acrylate, n-dodecyl (meth)acrylate, myristyl (meth)acrylate, palmityl (meth)acrylate, stearyl (meth)acrylate, cyclohexyl (meth)acrylate, isobornyl (meth)acrylate, and adamantyl (meth)acrylate. Among these, from the viewpoint of facilitating the adjustment of the delamination force to a desired value described later, methyl (meth)acrylate and 2-ethylhexyl (meth)acrylate are preferable. These may each be used alone or two or more types may also be used in combination.

The (meth)acrylic acid ester polymer preferably contains, as a monomer unit constituting the polymer, an alkyl (meth)acrylate in an amount of 30% to 99.9% by mass, particularly preferably 50% to 99.5% by mass, and further preferably 70% to 99% by mass based on all monomer units. When the value is within this range, the delamination force described later can be readily adjusted to a desired value.

The (meth)acrylic acid ester polymer contains a reactive functional group-containing monomer as a monomer unit constituting the polymer so that it reacts with a crosslinking agent described below via the reactive functional group derived from the reactive functional group-containing monomer, thereby forming a crosslinked structure (three-dimensional network structure). Thus, an adhesive having the desired cohesive strength can be obtained.

Preferred examples of the reactive functional group-containing monomer include a monomer having a hydroxy group in the molecule (hydroxy group-containing monomer), a monomer having a carboxy group in the molecule (carboxy group-containing monomer), and a monomer having an amino group in the molecule (amino group-containing monomer). Among these, from the viewpoint of ease of adjusting the crosslink density and of obtaining an adhesive having the desired cohesive strength and from the viewpoint of the delamination force described below, hydroxyl group-containing monomers or carboxyl group-containing monomers are preferable. These reactive functional group-containing monomers may each be used alone or two or more types may also be used in combination.

Examples of a hydroxy group-containing monomer include hydroxyalkyl (meth)acrylates such as 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, and 4-hydroxybutyl (meth)acrylate. Of the above, (meth)acrylic acid hydroxyalkyl esters having a hydroxyalkyl group with 1 to 4 carbon atoms are preferable. These may each be used alone or two or more types may also be used in combination.

Examples of a carboxy group-containing monomer include ethylenically unsaturated carboxylic acids such as acrylic acid, methacrylic acid, crotonic acid, maleic acid, itaconic acid, and citraconic acid. Among these, acrylic acid is preferable from the viewpoint of readily satisfying the delamination force described below. These may each be used alone or two or more types may also be used in combination.

The (meth)acrylic acid ester polymer contains, as a monomer unit constituting the polymer, a reactive functional group-containing monomer in an amount of preferably 0.1% to 20% by mass, more preferably 0.5% to 10% by mass, and particularly preferably 0.8% to 3% by mass based on all monomer units. This makes it easier for the (meth)acrylic acid ester polymer to undergo the desired crosslinking reaction with a crosslinking agent. As a result, the resulting adhesive tends to have excellent cohesive strength, making it easier to adjust the delamination force described later to a desired value.

The (meth)acrylic acid ester polymer may further contain other monomers as a monomer constituting the polymer. Examples of the other monomers include alicyclic structure-containing (meth)acrylic acid esters such as glycidyl (meth)acrylate, dicyclopentanyl (meth)acrylate, adamantyl (meth)acrylate, isobornyl (meth)acrylate, dicyclopentenyl (meth)acrylate, and dicyclopentenyloxyethyl (meth)acrylate; alkoxyalkyl (meth)acrylic acid esters such as methoxyethyl (meth)acrylate and ethoxyethyl (meth)acrylate; non-crosslinkable acrylamides such as acrylamide and methacrylamide; non-crosslinkable (meth)acrylic acid esters having a tertiary amino group such as N,N-dimethylaminoethyl (meth)acrylate and N,N-dimethylaminopropyl (meth)acrylate; vinyl acetate; and styrene. Among these, from the viewpoint of the cohesive strength of the resulting (meth)acrylic acid ester polymer (A) and the delamination force described below, glycidyl (meth)acrylate is preferable, and glycidyl methacrylate is particularly preferable. These may each be used alone or two or more types may also be used in combination.

The (meth)acrylic acid ester polymer contains, as a monomer unit constituting the polymer, another monomer in an amount of preferably 0.10% to 10% by mass, more preferably 0.2% to 5% by mass, and further preferably 0.3% to 1% by mass based on all monomer units. As a result, the resulting adhesive tends to have excellent cohesive strength, making it easier to adjust the delamination force described later to a desired value.

The polymerization mode of the (meth)acrylic acid ester polymer in the present embodiment may be a random polymer or a block polymer without particular limitations. The acrylic-based polymer can be obtained by polymerizing the above-described monomers by an ordinary method. For example, it can be prepared by polymerization using an emulsion polymerization method, a solution polymerization method, a suspension polymerization method, a bulk polymerization method, an aqueous solution polymerization method, or the like. Among these, from the viewpoints of stability during polymerization and ease of handling during use, preparation by solution polymerization in an organic solvent is preferable.

The weight average molecular weight of the (meth)acrylic acid ester polymer is preferably 100,000 to 3,000,000, more preferably 300,000 to 2,000,000, particularly preferably 450,000 to 1,500,000, and further preferably 600,000 to 1,000,000. As a result, the resulting adhesive tends to have excellent cohesive strength, making it easier to adjust the delamination force described later to a desired value.

The adhesive composition according to the present embodiment may contain one type of the above-described (meth)acrylic acid ester polymer, or may contain two or more types. Moreover, the adhesive composition according to the present embodiment may contain another (meth)acrylic acid ester polymer in addition to the above-described (meth)acrylic acid ester polymer.

When the crosslinking agent is contained, the (meth)acrylic acid ester polymer is crosslinked by heating the adhesive composition, making it possible to form an excellent three-dimensional network structure. This improves the cohesive strength of the resulting adhesive, making it easier to adjust the delamination force described later to a desired value.

Examples of the crosslinking agent are preferably those which react with the reactive functional group possessed by the (meth)acrylic acid ester polymer. Examples thereof include isocyanate-based crosslinking agents, epoxy-based crosslinking agents, amine-based crosslinking agents, melamine-based crosslinking agents, aziridine-based crosslinking agents, hydrazine-based crosslinking agents, aldehyde-based crosslinking agents, oxazoline-based crosslinking agents, metal alkoxide-based crosslinking agents, metal chelate-based crosslinking agents, metal salt-based crosslinking agents, and ammonium salt-based crosslinking agents.

Among the above-described crosslinking agents, an isocyanate-based crosslinking agent, an epoxy-based crosslinking agent, or an aziridine-based crosslinking agent can preferably be used from the viewpoint of ease in reacting with the reactive functional group possessed by the (meth)acrylic acid ester polymer, and from the viewpoint of ease in adjusting the delamination force described later to a desired value. The crosslinking agents can each be used alone or two or more types can also be used in combination.

In a case in which the adhesive composition contains a crosslinking agent and a (meth)acrylic acid ester polymer, the content of the crosslinking agent in the adhesive composition is preferably 0.01 to 5 parts by mass, more preferably 0.1 to 4 parts by mass, particularly preferably 0.5 to 3 parts by mass, and further preferably 1 to 2 parts by mass with respect to 100 parts by mass of the (meth)acrylic acid ester polymer. This allows the resulting adhesive to exhibit more excellent cohesive strength and also makes it easier to adjust the delamination force described later to a desired value.

The adhesive layer may also contain other components depending on the purpose.

Examples of other components include a tackifier, a plasticizer, an antistatic agent, an ultraviolet absorber, a silane coupling agent, a rust inhibitor, an antioxidant, a light stabilizer, a softener, and a refractive index adjuster. The polymerization solvent and dilution solvent derived from the production of (meth)acrylic acid ester polymer are not included in the additives constituting the adhesive composition.

In a case in which the adhesive composition contains a plasticizer, the content of the plasticizer in the adhesive composition is preferably 0.1 to 50 parts by mass, more preferably 1 to 35 parts by mass, particularly preferably 4 to 20 parts by mass, and further preferably 8 to 15 parts by mass with respect to 100 parts by mass of the (meth)acrylic acid ester polymer. This allows the resulting adhesive to exhibit more excellent cohesive strength and also makes it easier to adjust the delamination force described later to a desired value.

The storage modulus of the adhesive according to the present disclosure is preferably 0.010 to 1 MPa, more preferably from 0.011 to 0.6 MPa, and particularly preferably 0.012 to 0.3 MPa. This allows the adhesive layer and the writing feel improving layer to readily exhibit moderate adhesion, resulting in an excellent peeling off suppression effect.

The storage modulus can be measured in accordance with JIS K7244-1.

The thickness a of the adhesive layer is preferably 3 μm or more, more preferably 5 μm or more, and particularly preferably 10 μm or more. The thickness of the adhesive layer is usually 300 μm or less. From the viewpoint of well reproducing the writing feel experienced when writing on paper with a ballpoint pen and the viewpoint of reducing the total thickness of a touch panel provided with the writing feel improving film, the thickness of the adhesive layer is preferably 200 μm or less, more preferably 100 μm or less, particularly preferably 50 μm or less, and further preferably 30 μm or less.

In addition, as described later, the thickness a (μm) of the adhesive layer needs to be designed so that the ratio between the WEM of the writing feel improving layer of the writing feel improving film and the thickness a (WEM/a) is 0.01 to 1.00.

### (3) Protective Film

The method of producing a protective film having an adhesive layer is not particularly limited. For example, a protective film can be formed by applying a composition for forming an adhesive layer to a desired thickness on a protective film base material layer by a known coating method and drying the resulting coating film.

The composition for forming an adhesive layer usually contains a base polymer, a solvent, a crosslinking agent, and optionally fine particles, a tackifier, a plasticizer, an antistatic agent, an ultraviolet absorbing agent, and the like.

The protective film can also be produced by forming the adhesive layer on the writing feel improving layer as described above, stacking a protective film base material thereon, and pressing them together (laminating them).

### 3) Protective Film-Equipped Writing Feel Improving Film

The protective film-equipped writing feel improving film of the present disclosure is formed by laminating the writing feel improving layer of the writing feel improving film on the adhesive layer of the protective film so as to be in contact therewith.

The protective film-equipped writing feel improving film of the present disclosure may be in a long shape (strip-like) or a rectangular shape (sheet-like).

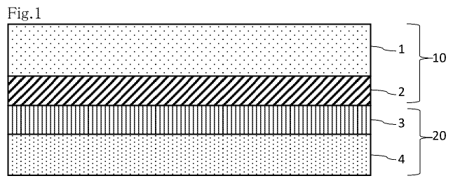

FIG. 1 is a schematic diagram illustrating a layer structure of the protective film-equipped writing feel improving film of the present disclosure.

In other words, a writing feel improving film 10 and a protective film 20 are laminated such that a writing feel improving layer 2 and an adhesive layer 3 of the protective film are in contact with each other in the protective film-equipped writing feel improving film of the present disclosure.

The method for producing a protective film-equipped writing feel improving film of the present disclosure is not particularly restricted. For example, the protective film-equipped writing feel improving film can be produced by laminating the writing feel improving film and the protective film so that the writing feel improving layer and the adhesive layer are in contact with each other.

In addition, as described above, the protective film-equipped writing feel improving film of the present disclosure can also be produced by forming the adhesive layer on the writing feel improving layer of the writing feel improving film and laminating a protective film base material thereon.

For the protective film-equipped writing feel improving film of the present disclosure, the ratio of the maximum height of rolling circle waviness profile (VEM) of the writing feel improving layer to thickness a (μm) of the adhesive layer “WEM/a” is preferably 0.01 or more, more preferably more than 0.01, particularly preferably 0.03 or more, further preferably 0.06 or more, and still further preferably 0.07 or more. In addition, “WEM/a” is preferably 1.00 or less, more preferably less than 1.00, particularly preferably 0.80 or less, further preferably 0.70 or less, and still further preferably 0.60 or less.

The protective film-equipped writing feel improving film of the present disclosure has been designed so that the “WEM/a” value falls within such ranges. Therefore, even when temperature changes occur during storage, transportation, processing, or the like, interlayer lifting or peeling off between the protective film and the writing feel improving film is unlikely to occur, allowing the quality of the writing feel improving film to be maintained.

It may be preferred to (i) adjust thickness a of the adhesive layer of the protective film in accordance with the WEM of the writing feel improving layer or (ii) use a writing feel improving film including a writing feel improving layer having an appropriate WEM in accordance with thickness a of the adhesive layer of the protective film so that the “WEM/a” value falls within the above-described ranges for the protective film-equipped writing feel improving film of the present disclosure.

It can be confirmed that interlayer lifting or peeling off is unlikely to occur between the protective film and the writing feel improving film by, for example, observing that even after placing a sample of the protective film-equipped writing feel improving film (5 cm×5 cm) in an oven maintained at 90° C. and leaving the sample for 1 hour, peeling off from the edge of the sample is within 1 cm. The degree of peeling off from the edge is preferably less than 1 cm, more preferably less than 0.5 cm, particularly preferably less than 0.3 cm, and further preferably less than 0.1 cm.

The delamination force between the writing feel improving film and the protective film is preferably 800 mN/25 mm or less for the protective film-equipped writing feel improving film of the present disclosure. Details are provided below.

The delamination force between the writing feel improving layer surface of the writing feel improving film and the protective film is preferably 800 mN/25 mm or less, more preferably 500 mN/25 mm or less, particularly preferably 300 mN/25 mm or less, further preferably 200 mN/25 mm or less, and still further preferably 150 mN/25 mm or less for the protective film-equipped writing feel improving film of the present disclosure after being placed in an oven maintained at 90° C. and left for 1 hour.

In addition, the lower limit of the delamination force is preferably 1 mN/25 mm or more, more preferably 3 mN/25 mm or more, particularly preferably 6 mN/25 mm or more, and further preferably 10 mN/25 mm or more from the viewpoint of preventing problems such as the protective film accidentally lifting or peeling off from the writing feel improving film when exposed to temperature changes.

By having such a delamination force, the occurrence of lifting or peeling off due to temperature changes during storage, transportation, processing, and the like can be more effectively controlled, the quality of the writing feel improving film can be maintained, and the protective film can be readily peeled and removed from the writing feel improving film when in use.

The delamination force between the writing feel improving layer surface of the writing feel improving film and the protective film for the protective film-equipped writing feel improving film of the present disclosure before being subjected to a thermal history due to temperature changes, for example, at 90° C. for 1 hour is preferably 800 mN/25 mm or less, more preferably 500 mN/25 mm or less, particularly preferably 200 mN/25 mm or less, further preferably 120 mN/25 mm or less, and still further preferably 90 mN/25 mm or less.

In addition, the lower limit of the delamination force is preferably 5 mN/25 mm or more, more preferably 8 mN/25 mm or more, particularly preferably 11 mN/25 mm or more, and further preferably 14 mN/25 mm or more from the viewpoint of preventing problems such as the protective film accidentally lifting or peeling off from the writing feel improving film when exposed to temperature changes.

By having such a delamination force, the occurrence of lifting or peeling off due to temperature changes during storage, transportation, processing, and the like can be more effectively controlled, the quality of the writing feel improving film can be maintained, and the protective film can be readily peeled and removed from the writing feel improving film when in use.

The delamination force between the writing feel improving film and the protective film can be measured by the methods described in Examples.

The protective film-equipped writing feel improving film of the present disclosure can be used as a writing feel improving film that constitutes the outermost layer of a touch panel (image display device with position detection fuinction) on which a touch pen is used when the protective film is removed by peeling from the writing feel improving film.

Specifically, the writing feel improving film is laminated on the cover material of a display body module such as a liquid crystal (LCD) module, alight emitting diode (LED) module, or an organic electroluminescence (organic EL) module or the cover material of a touch panel having a touch sensor or the like so that the cover material is in contact with the surface of the writing feel improving film base material layer. The writing feel improving film may be attached via a binder layer.

The touch pen used with the writing feel improving film is not particularly limited, and examples thereof include those having a polyacetal pen tip, those having a hard felt pen tip, and those having an elastomer pen tip.

It should be appreciated that the embodiments heretofore explained are described to facilitate understanding of the present disclosure and are not described at all to limit the present disclosure. It is therefore intended that the elements disclosed in the above embodiments include all design changes and equivalents to fall within the technical scope of the present disclosure.

For example, a different layer may be laminated on the protective film-equipped writing feel improving film of the present disclosure. The other layers include a binder layer, a release film, and the like, which are laminated on the writing feel improving film base material layer.

In a case in which it is herein described as “X to Y” (X and Y are arbitrary numbers), it includes the meaning of “from X to Y,” as well as the meaning of “preferably larger than X” or “preferably smaller than Y” unless otherwise specified. In a case in which it is herein described as “X or more” (X is any number), it also includes the meaning of “preferably greater than X” unless otherwise specified. In a case in which it is described as “Y or less” (Y is any number), it also includes the meaning of “preferably smaller than Y” unless otherwise specified.

### EXAMPLES

Hereinafter, the present disclosure described further specifically with reference to examples and the like but the scope of the present disclosure is not limited to these examples and the like.

### (Production Example 1) Preparation of Writing Feel Improving Film A

A composition for forming a writing feel improving layer A was prepared by mixing 100 parts by mass of an active energy ray-curable component containing polyfunctional urethane acrylate (product name: “OPSTAR Z7530” available from ARAKAWA CHEMICAL INDUSTRIES, LTD.) (expressed as a solid content equivalent, the same applies below to other components other than the solvent), 9.0 parts by mass of silicone fine particles (Tospearl 1100 available from Momentive Performance Materials Japan, average particle diameter: 11.0 μm, genuinely spherical), 1.0 parts by mass of a fluorine-based surface conditioner (Megafac RS-90 available from DIC), 0.3 parts by mass of a silicone-based surface conditioner (SH28, polydimethylpolysiloxane available from Dow Toray Co., Ltd.), and 85.5 parts by mass of 1-methoxy-2-propanol as a solvent.

The composition for forming a writing feel improving layer A was applied to a polyethylene terephthalate (PET) film (Lumirror U403, thickness: 188 μm, available from Toray Industries, Inc.) as a writing feel improving film base material layer with a Mayer bar, thereby forming a coating film having a film thickness of 7 μm. The coating film was placed in an oven maintained at 70° C. for 1 minute for drying.

Next, using an ultraviolet irradiation device (Eigrantage ECS-401GX type available from EYE GRAPHICS COMPANY), ultraviolet irradiation was performed using a high-pressure mercury lamp as a light source under the following irradiation conditions to harden the coating film, thereby preparing a writing feel improving film A.

### (Ultraviolet Irradiation Conditions)

Lamp power: 2 kW
Conveyor speed: 4.23 m/min
Illuminance: 240 mW/cm²
Light amount: 307 mJ/cm²

The maximum height of rolling circle waviness profile (WEM), arithmetic average roughness (Ra), and ten-point average roughness (RzJIS) of the writing feel improving layer of the obtained writing feel improving film A were measured by the methods described below.

The WEM, Ra, and RzJIS of the writing feel improving layer of the obtained writing feel improving film A were 2.40 μm, 0.66 μm, and 6.14 μm, respectively.

### <Maximum Height of Rolling Circle Waviness Profile (WEM)>

The WEM was measured under the following conditions using a surface roughness and shape measuring machine (SV3000S4 available from Mitutoyo Corporation) in accordance with JIS B0610:2001.
Probe tip shape: Spherical
Probe tip radius: 800 ptm
Sliding speed: 0.5 mm/s
Measurement length: 16 mm

### <Ra, RzJIS>

For the surfaces of the writing feel improving layers of the writing feel improving sheets A, B, and C, the arithmetic average surface roughness Ra (μm) and the ten-point average surface roughness RzJIS (μm) were measured using a surface roughness and shape measuring machine (SV3000S4 available from Mitutoyo Corporation) in accordance with JIS B0601:2013.

### (Production Example 2) Preparation of Writing Feel Improving Film B

A writing feel improving film B was prepared in the same manner as in Production Example 1, except that 9.0 parts by mass of silicone fine particles in Production Example 1 were replaced with 1 part by mass of spherical fine particles composed of crosslinked polymethyl methacrylate (SSX-110, average particle size: 10 μm, available from Sekisui Kasei Co., Ltd.).

The WEM, Ra, and Rz of the writing feel improving layer of the obtained writing feel improving film B were 6.28 μm, 0.26 μm, and 4.03 μm, respectively.

### (Production Example 3) Preparation of Writing Feel Improving Film C

A writing feel improving film C was prepared in the same manner as in Production Example 1, except that 9.0 parts by mass of silicone fine particles in Production Example 1 were replaced with 1 part by mass of spherical fine particles composed of crosslinked polymethyl methacrylate (SSX-120, average particle size: 20 jam, available from Sekisui Kasei Co., Ltd.).

The WEM, Ra, and Rz of the writing feel improving layer of the obtained writing feel improving film C were 15.5 μm, 0.34 μm, and 8.92 μm, respectively.

### (Measurement of Frictional Force)

The frictional force during writing using the obtained writing feel improving films A, B, and C and a stylus pen (product name “ACK-2003”, pen tip material: felt, pen tip diameter: 0.5 mm, available from Wacom Co., Ltd.) was measured under the following conditions using a static and dynamic friction measuring device (Tribomaster TL201 Ts, manufactured by Trinity Labs Co., Ltd.).

### (Measurement Conditions)

Load: 200 g
Test length: 10 to 100 mm
Speed: 1.6 mm/s (vibration measurement conditions, dynamic friction coefficient measurement conditions)
Sampling pitch: 50 ms
Stylus pen tip angle: 450

The writing feel improving film A had an average frictional force of 310 mN, a maximum frictional force of 350 mN, a minimum frictional force of 240 mN, and a standard deviation of frictional force of 17 mN. The writing feel improving film B had an average frictional force of 220 mN, a maximum frictional force of 280 mN, a minimum frictional force of 220 mN, and a standard deviation of frictional force of 17 mN. The writing feel improving film C had an average frictional force of 190 mN, a maximum frictional force of 240 mN, a minimum frictional force of 210 mN, and a standard deviation of frictional force of 22 mN.

### (Pencil Hardness)

The pencil hardness of the surface on the writing feel improving layer side was measured in accordance with JIS K5600 using a pencil scratch hardness tester (product name “No. 553-M” available from YASUDA SEIKI SEISAKUSHO, LTD.) for the obtained writing feel improving films A, B, and C.

The pencil hardness of the writing feel improving film A was 4H, and the pencil hardness of the writing feel improving films B and C was 3H.

### (Scratch Resistance)

The surface on the writing feel improving layer side was rubbed at a load of 250 g/cm² using #0000 steel wool to reciprocate it ten times within a sliding distance of 10 cm in accordance with JIS K5600-5-10 for the writing feel improving films A, B, and C. Thereafter, the surface on the writing feel improving layer side visually confirmed under a three-wavelength fluorescent lamp for the presence or absence of scratches and was evaluated according to the following criteria.
∘ (Excellent): No change was observed in the appearance of the writing feel improving layer (0 scratches were confirmed).
Δ (Fair): Moderate changes were observed in the appearance of the writing feel improving layer (one or two scratches were confirmed).
× (Poor): Obvious changes were observed in the appearance of the writing feel improving layer (not less than four scratches were confirmed).

As a result, the writing feel improving films A and B were rated as ∘, while the writing feel improving film C was rated as Δ.

### (Production Example 4) Preparation of Composition for Forming Adhesive Layer D

A (meth)acrylic acid ester polymer was prepared by copolymerizing 70 parts by mass of 2-ethylhexyl acrylate, 28.6 parts by mass of methyl acrylate, 0.3 parts by mass of glycidyl methacrylate, and 1.1 parts by mass of acrylic acid. The molecular weight of the resulting (meth)acrylic acid ester polymer was measured by the method described below. The weight average molecular weight (Mw) was found to be 800,000.

The weight average molecular weight (Mw) is a polystyrene-equivalent weight average molecular weight measured by gel permeation chromatography (GPC) under the following conditions (GPC measurement).

### (Measurement Conditions)

GPC measurement device: HLC-8020 available from Tosoh Corporation
GPC columns (passed in the following order) available from Tosoh Corporation
   TSK guard column HXL-H
   TSK gel GMHXL (×2)
   TSK gel G2000HXL
Measurement solvent: Tetrahydrofuran
Measurement temperature: 40° C.

A composition for forming an adhesive layer D was prepared by mixing 100 parts by mass of the (meth)acrylic acid ester polymer (expressed as a solid content equivalent, the same applies below to other components other than the solvent) obtained above, 10.0 parts by mass of dibutoxyethoxyethyl adipate as a plasticizer, 0.9 parts by mass of an aziridine-based crosslinking agent (BXX-5134 available from TOYOCHEM CO., LTD.) as a cross-linker, and 87 parts by mass of toluene as a solvent.

### (Production Example 5) Preparation of Composition for Forming Adhesive Layer E

A composition for forming an adhesive layer E was prepared in the same manner as in Production Example 4, except that 1.9 parts by mass of the crosslinking agent was used instead of 0.9 parts by mass in Production Example 4.

### (Production Example 6) Preparation of Composition for Forming Adhesive Layer F

A composition for forming an adhesive layer F was prepared in the same manner as in Production Example 4, except that 2.8 parts by mass of the crosslinking agent was used instead of 0.9 parts by mass in Production Example 4.

### Example 1

The composition for forming an adhesive layer D obtained in Production Example 4 was applied to a polyethylene terephthalate (PET) film (Lumirror, thickness: 38 μm, available from Toray Industries, Inc.) as a protective film base material layer with an applicator, thereby forming a coating film of an adhesive layer having a film thickness of 10 μm. The coating film was then placed in an oven maintained at 100° C. for 1 minute for drying, thereby obtaining a protective film consisting of the protective film base material layer and the adhesive layer.

Next, the adhesive layer of the obtained protective film was laminated so as to be in contact with the surface of the writing feel improving layer of the writing feel improving film A obtained in Production Example 1, thereby producing a protective film-equipped writing feel improving film.

### Examples 2 to 15, Comparative Examples 1 to 3

Protective film-equipped writing feel improving films of Examples 2 to 15 and Comparative Examples 1 to 3 were prepared in the same manner as in Example 1, the types of the writing feel improving film and the composition for forming an adhesive layer used in Example 1 and the thickness of the adhesive layer were replaced with those listed in Table 1 below.

The ratios of the maximum height of rolling circle waviness profile (WEM) to the thickness a of the adhesive layers of the protective film-equipped writing feel improving films obtained in Examples 1 to 15 and Comparative Examples 1 to 3 are listed in Table 1.

A peeling off test was performed by the method described below for each of the protective film-equipped writing feel improving films obtained in Examples 1 to 15 and Comparative Examples 1 and 3.

The results are listed in Table 1.

### <Peeling Off Test>

Each obtained protective film-equipped writing feel improving film was cut into a 5 cm square, which was designated as a sample. The sample was placed in an oven maintained at 90° C. with the protective film side facing downward. After the sample was left in the oven for 1 hour, the peeling off that occurred between the writing feel improving layer and the protective film (cm) was measured and evaluated according to the following criteria.

The temperature before the test was 23° C.
5: No peeling off was observed.
4: Peeling off of less than 0.5 cm from the edge was observed.
3: Peeling off of 0.5 cm to less than 1.0 cm from the edge was observed.
2: Peeling off of 1.0 cm to less than 1.5 cm from the edge was observed.
1: Peeling off of not less than 1.5 cm from the edge was observed.

The delamination force (adhesive strength) between the protective film and the writing feel improving film before and after the peeling off test, and the writing feel of the writing feel improving film after the peeling off test were measured by the methods described below.

The results are listed in Table 1.

### <Delamination Force>

The obtained protective film-equipped writing feel improving films were cut into test pieces having a width of 25 mm and a length of 110 mm. For the obtained test pieces, a tensile testing machine (TENSILON available from ORIENTEC CO., LTD.) was used to measure the delamination force (N/25 mm) when the protective film was peeled off from the writing feel improving film under conditions of a peel speed of 300 mm/min and a peel angle of 180° in accordance with JIS Z0237:2009.

### <Evaluation of Writing Feel>

Paper (product name “Campus Loose Leaf,” product model number: “NO-S816B,” size: B5, ruled width: B-ruled, 20 sheets stacked when used) and a ballpoint pen (product name “Orange EG 1.0,” oil-based ballpoint pen, pen tip diameter: 1.0 mm, available from BIC) were prepared. An evaluator wrote the letters “ABCDE” on the paper with the ballpoint pen.

Next, the protective film was peeled off from the protective film-equipped writing feel improving film after the peeling off test, and the film was attached to a glass plate (length: 70 mm, width: 150 mm, thickness: 1.2 mm) using double-sided tape so that the writing feel improving layer was exposed. The letters “ABCDE” were written on the surface of the writing feel improving layer using the stylus pen.
The writing feel (x) of actually writing on paper with the ballpoint pen was compared with the writing feel (y) of writing on the writing feel improving layer with the stylus pen, and the writing feel was evaluated according to the following criteria.

### (Evaluation Criteria)

⊚ (Significantly excellent): The writing feel (y) was very similar to the writing feel (x) in terms of the feelings of vibration and resistance, resulting in a favorable writing comfort.
∘ (Excellent): The writing feel (y) was similar to but slightly different from the writing feel (x) in terms of the feelings of vibration and resistance, which, however, resulted in a favorable writing comfort.
Δ (Fair): The writing feel (y) was different from the writing feel (x) in terms of the feelings of vibration and resistance, which, however, resulted in an acceptable writing comfort.
× (Poor): The writing feel (y) was different from the writing feel (x) in terms of the feelings of vibration and resistance, resulting in difficulty in writing and a poor writing comfort.

TABLE 1

| | Writing feel | | | | | | Delamination | | |
|---|---|---|---|---|---|---|---|---|---|
| | improving | | Protective film | | | | force | | |
| | layer | | adhesive layer | | | Peeling | (mN/25 mm) | | Writing |
| | | WEM | | Thickness a | | off test | Before | After | feel |
| | Type | (μm) | Type | (μm) | WEM/a | evaluation | testing | testing | evaluation |
| Example 1 | A | 2.4 | D | 10 | 0.24 | 5 | 50 | 65 | ⊚ |
| Example 2 | | | | 30 | 0.08 | 5 | 85 | 130 | ⊚ |
| Example 3 | | | E | 10 | 0.24 | 4 | 43 | 35 | ⊚ |
| Example 4 | | | | 30 | 0.08 | 5 | 55 | 75 | ⊚ |
| Example 5 | | | F | 10 | 0.24 | 4 | 28 | 33 | ⊚ |
| Example 6 | | | | 30 | 0.08 | 5 | 50 | 63 | ⊚ |
| Example 7 | B | 6.3 | D | 10 | 0.63 | 4 | 28 | 18 | ◯ |
| Example 8 | | | | 30 | 0.21 | 5 | 68 | 90 | ◯ |
| Example 9 | | | E | 10 | 0.63 | 3 | 25 | 15 | ◯ |
| Example 10 | | | | 30 | 0.21 | 5 | 40 | 45 | ◯ |
| Example 11 | | | F | 10 | 0.63 | 3 | 20 | 10 | ◯ |
| Example 12 | | | | 30 | 0.21 | 4 | 35 | 25 | ◯ |
| Example 13 | C | 15.5 | D | 30 | 0.52 | 5 | 80 | 75 | Δ |
| Example 14 | | | F | 30 | 0.52 | 4 | 33 | 10 | Δ |
| Example 15 | | | F | 30 | 0.52 | 3 | 15 | 8 | Δ |
| Comparative | | | D | 10 | 1.55 | 2 | 50 | 25 | X |
| Example 1 | | | | | | | | | |
| Comparative | | | E | 10 | 1.55 | 2 | 40 | 20 | X |
| Example 2 | | | | | | | | | |
| Comparative | | | F | 10 | 1.55 | 1 | 10 | 5 | X |
| Example 3 | | | | | | | | | |

From Table 1, it can be seen that the protective film-equipped writing feel improving films of Examples 1 to 15, in which the WEM/a value is 0.01 to 1.00, have a score of 3 or more in the peeling off test evaluation and the occurrence of lifting or peeling off due to heat is suppressed.

Further, the writing feel is also excellent, and it can be seen that the quality of the writing feel improving layer is maintained.

Meanwhile, the score of the peeling off test evaluation was 1 or 2 in Comparative Examples 1 to 3, indicating that peeling off occurred due to heat, impairing the quality of the writing feel improving layer.

### REFERENCE SIGNS LIST

1 Writing feel improving film base material layer
2 Writing feel improving layer
3 Adhesive layer
4 Protective film base material layer
10 Writing feel improving film
20 Protective film

1. A protective film-equipped writing feel improving film which is formed by laminating a writing feel improving film having a writing feel improving film base material layer and a writing feel improving layer with a protective film having an adhesive layer and a protective film base material layer, thereby allowing the writing feel improving layer of the writing feel improving film and the adhesive layer of the protective film to be in contact with each other,
wherein a ratio of a maximum height of rolling circle waviness profile (WEM) of the writing feel improving layer to a thickness a (μm) of the adhesive layer (WEM/a) is 0.01 to 1.00.

2. The protective film-equipped writing feel improving film according to claim 1, wherein the maximum height of rolling circle waviness profile (WEM) of the writing feel improving layer is 0.1 μm to 20 μm.

3. The protective film-equipped writing feel improving film according to claim 1, wherein the thickness a (μm) of the adhesive layer is 5 μm to 50 μm.

4. The protective film-equipped writing feel improving film according to claim 1, wherein a delamination force between the writing feel improving film and the protective film is 800 mN/25 mm or less.

5. The protective film-equipped writing feel improving film according to claim 2, wherein the thickness a (μm) of the adhesive layer is 5 μm to 50 μm.

6. The protective film-equipped writing feel improving film according to claim 2, wherein a delamination force between the writing feel improving film and the protective film is 800 mN/25 mm or less.
